(19) United States
(12) Patent Application Publication
(10) Pub. No.: US 2025/0197559 A1
(43) Pub. Date: Jun. 19, 2025

(54) OLIGOSILOXANE EPOXY COVALENT ADAPTABLE NETWORKS

(71) Applicant: Government of the United States, as represented by the Secretary of the Air Force, Wright-Patterson AFB, OH (US)

(72) Inventors: Luke A. Baldwin, Springfield, OH (US); Amelia A. Neeb, Williamston, SC (US); Alex M. Stafford, Fairborn, OH (US)

(21) Appl. No.: 18/976,676

(22) Filed: Dec. 11, 2024

Related U.S. Application Data
(60) Provisional application No. 63/610,581, filed on Dec. 15, 2023.

(51) Int. Cl. C08G 59/30; C08G 59/42; C08G 59/66; C08G 59/68

(52) U.S. Cl. CPC C08G 59/306; C08G 59/4207; C08G 59/4223; C08G 59/4284; C08G 59/66; C08G 59/686

(57) ABSTRACT

The present invention relates to oligosiloxane epoxy based dynamic adaptable networks and processes of making and using the same. Articles produced from such oligosiloxane dual-dynamic adaptable networks exhibit good structural integrity yet are reprocessable. Such articles can form chemical bond welds with other articles that possess siloxane and/or ester functionality within the network.

### CROSS-REFERENCE TO RELATED APPLICATION

The present application claims priority to U.S. Provisional Application Ser. No. 63/610,581 filed Dec. 15, 2023, the contents of which is hereby incorporated by reference in their entry.

### RIGHTS OF THE GOVERNMENT

The invention described herein may be manufactured and used by or for the Government of the United States for all governmental purposes without the payment of any royalty.

### FIELD OF THE INVENTION

The present invention relates to oligosiloxane epoxy covalent adaptable networks and processes of making and using same.

### BACKGROUND OF THE INVENTION

Articles made from thermoset polymers have desirable structural integrities due to the covalent crosslinking of such polymers when the article is made. Unfortunately, due to such irreversible crosslinking, articles made from thermoset polymers cannot be recycled or reprocessed into new articles. Another drawback of thermoset polymers is that once they are processed into an article, such article cannot form a chemical bond weld to another cured article. On the other hand, articles produced from thermoplastics can be readily recycled and reproduced into new articles but lack the structural integrity that thermosets can provide.

Applicants recognized that the source of the aforementioned problems with thermosetting polymers was that articles made from thermoset polymers lack dynamic bonds. Applicants discovered that dynamic materials and weldability can be obtained in articles made from thermosetting polymers if the moieties within the polymer network are judiciously selected. While not being bound by theory, Applicants believe that such dynamic materials and chemical bonded weldability are obtained via transesterification and/or siloxane exchange pathways of the networks presented here.

### SUMMARY

The present invention relates oligosiloxane epoxy covalent adaptable networks and processes of making and using the same. Articles produced from oligosiloxane epoxy covalent adaptable networks exhibit good structural integrity yet are reprocessable. Such articles can form chemical bond welds with other articles that possess siloxane and/or ester functionality within the network.

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately”, or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A and/or B) that the embodiment may have element A alone, element B alone, or elements A and B taken together.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Oligosiloxane Epoxy Covalent Adaptable Networks and Articles Comprising Same

For purposes of this specification, headings are not considered paragraphs of the present specification. The individual number of each paragraph above and below this paragraph can be determined by reference to this paragraph's number. In this paragraph, Applicants disclose an oligosiloxane epoxy covalent adaptable network derived from the reaction of one or more siloxane diepoxides; preferably said one or more siloxane diepoxides have a structure selected from the group consisting of:

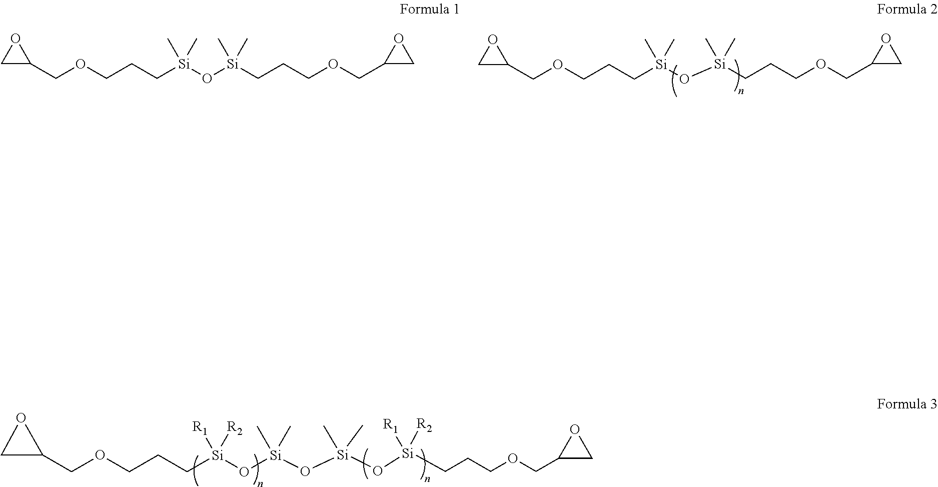

wherein for said Formula 1, Formula 2 and Formula 3 each indice n is independently an integer from 0 to 10; preferably each indice n is independently an integer from 1 to 5; and for Formula 3, R₁ and R₂ are each independently an alkyl moiety, an aryl moiety or an alkoxy moiety, preferably for Formula 3, R₁, and R₂ are each independently —CH₃, —CH₂CH₃, —CH₂CH₂CH₃, —C₆H₅, —C₁₀H₈, —OCH₃, —OCH₂CH₃;
one or more dicarboxylic acids and/or one or more multifunctional thiols, preferably said one or more dicarboxylic acids and one or more thiols have a structure selected from the group consisting of:

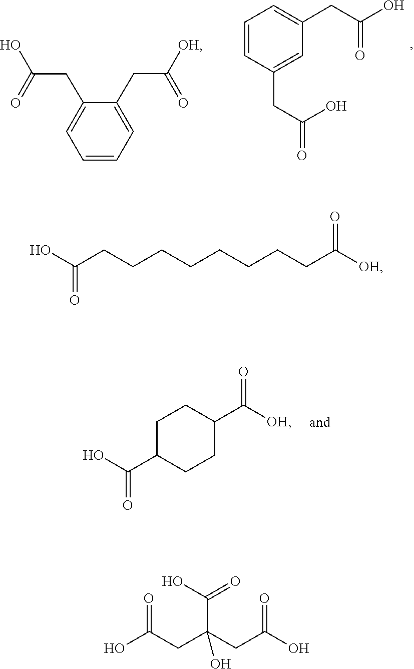 [SMILES: O=C(O)Cc1ccccc1CC(=O)O ; O=C(O)Cc1cccc(CC(=O)O)c1 ; O=C(O)CCCCCCCCC(=O)O ; O=C(O)C1CCC(C(=O)O)CC1 ; O=C(O)CC(O)(CC(=O)O)C(=O)O]

preferably said one or more dicarboxylic acids has the following structure:

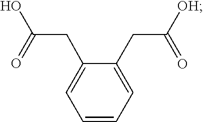 [SMILES: O=C(O)Cc1ccccc1CC(=O)O]

preferably said multifunctional thiols have a structure selected from the group consisting of:

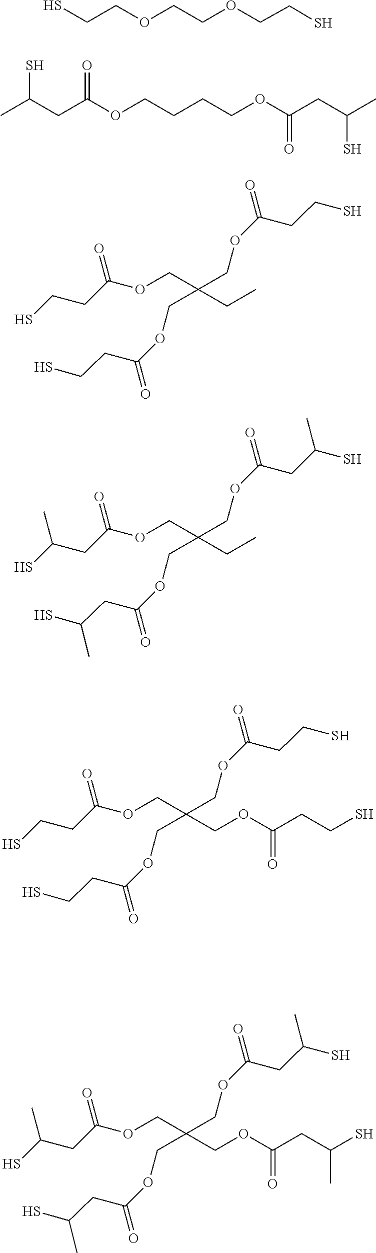

a catalyst selected from the group consisting of a Lewis Acid or non-nucleophilic base and mixtures thereof, preferably said non-nucleophilic base is selected from the group of non-nucleophilic bases having one or more of the structures below:

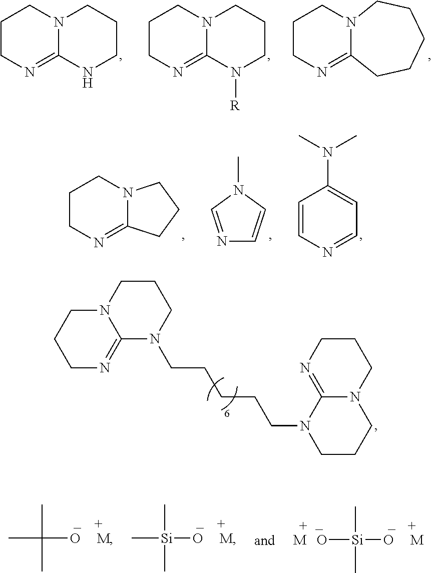

wherein R is a C₁ to C₁₀ alkyl; preferably said R is -methyl, or -isopropyl, and M is a counteranion; preferably said M is potassium, sodium, tetramethyl ammonium; preferably said Lewis Acid is selected from the group of Lewis Acids having one or more of the structures below:

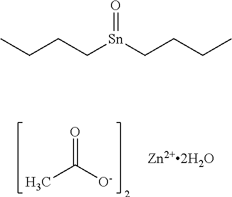

more preferably said catalyst has the following structure:

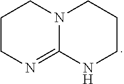

Applicants disclose an oligosiloxane epoxy covalent adaptable network according to the previous paragraph wherein said one or more oligosiloxane epoxides and said one or more carboxylic acids are present, prior to being reacted, in a stoichiometric ratio of from about 2:1 to about 1:2, preferably said one or more oligosiloxane epoxides and said one or more carboxylic acids are present, prior to being reacted, in a stoichiometric ratio of from about 1.5:1 to about 1:1.5, more preferably said one or more oligosiloxane epoxides and said one or more carboxylic acids are present, prior to being reacted, in a stoichiometric ratio of from about 1:0.9 to about 0.9:1 and/or said one or more oligosiloxane epoxides and said one or more multifunctional thiols, are present, prior to being reacted, in an epoxy:thiol ratio from about 2:1 to about 1:2, preferably said one or more oligosiloxane epoxides and said one or more one or more multifunctional thiols, being present prior to being reacted, in an epoxy:thiol ratio from about 1.5:1 to about 1:1.5, more preferably said one or more oligosiloxane epoxides and said one or more multifunctional thiols being present, prior to being reacted, in an epoxy:thiol ratio of from about 1:0.9 to about 0.9:1.

Applicants disclose an article comprising an oligosiloxane epoxy covalent adaptable network according to the previous two paragraphs and/or an oligosiloxane epoxy covalent adaptable network made according to the processes of the first paragraphs of the section of this specification titled “Processes of Making and Recycling Oligosiloxane Epoxy Covalent Adaptable Networks”, said article preferably being an actuator, coating material or a soft robotic structural unit.

### Processes of Making and Recycling Oligosiloxane Epoxy Covalent Adaptable Networks

Applicants disclose a process of making an oligosiloxane epoxy covalent adaptable network comprising combining one or more siloxane diepoxides; preferably said one or more siloxane diepoxides have a structure selected from the group consisting of:

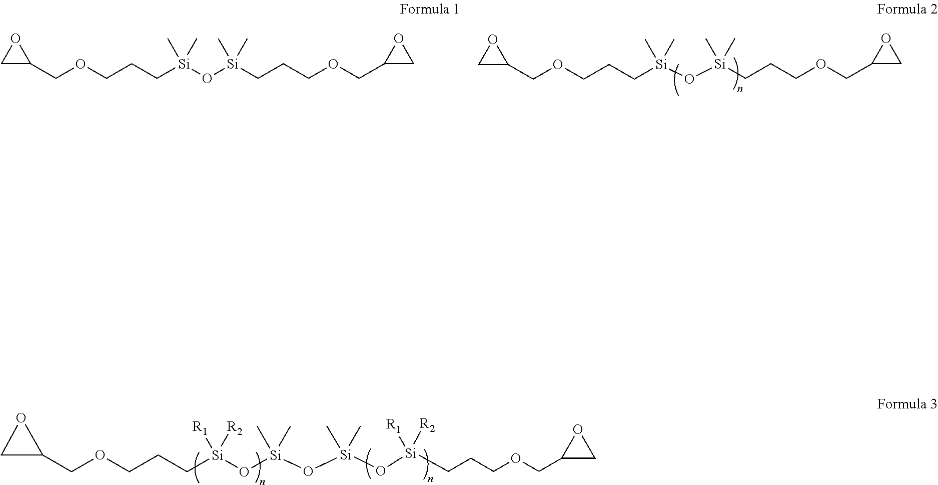

wherein for said Formula 1, Formula 2 and Formula 3 each indice n is independently an integer from 1 to 10, preferably each indice n is independently an integer from 1 to 5; and for Formula 3, R₁ and R₂ are each independently an alkyl moiety, an aryl moiety or an alkoxy moiety, preferably for Formula 3, R₁ and R₂ are each independently —CH₃, —CH₂CH₃, —CH₂CH₂CH₃, —C₆H₅, —C₁₀H₈, —OCH₃, —OCH₂CH₃;
one or more dicarboxylic acids and/or one or more multifunctional thiols preferably said one or more dicarboxylic acids have a structure selected from the group consisting of:

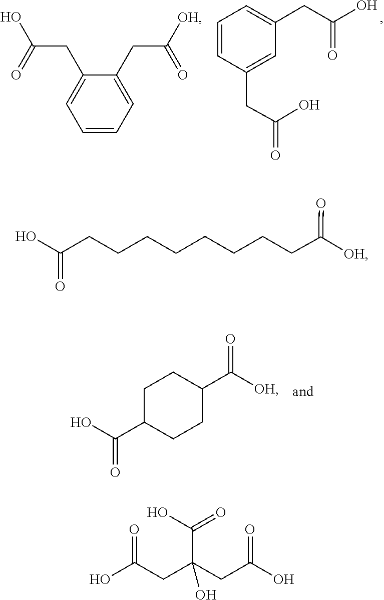

preferably said one or more dicarboxylic acids has the following structure:

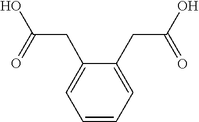 [SMILES: O=C(O)Cc1ccccc1CC(=O)O]

preferably said multifunctional thiols have a structure selected from the group consisting of:

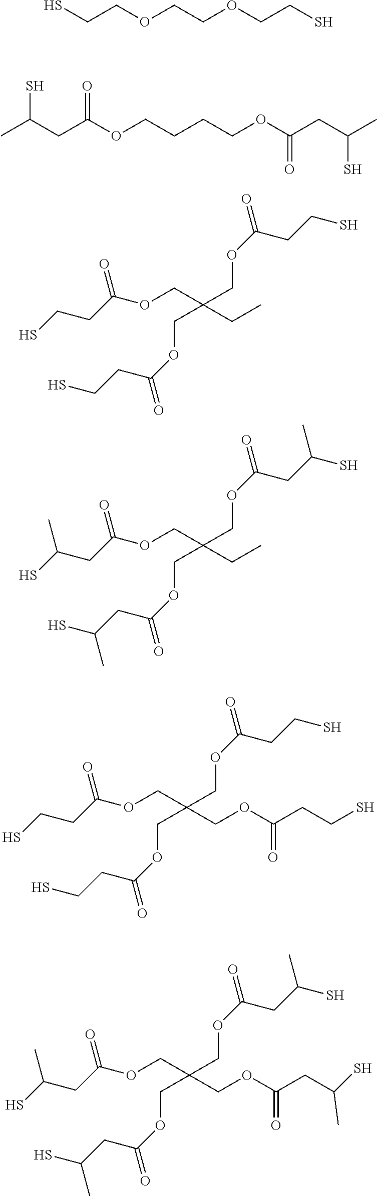 [SMILES: SCCOCCOCCS ; CC(S)CC(=O)OCCCCOC(=O)CC(C)S ; CCC(COC(=O)CCS)(COC(=O)CCS)COC(=O)CCS ; CCC(COC(=O)CC(C)S)(COC(=O)CC(C)S)COC(=O)CC(C)S ; O=C(CCS)OCC(COC(=O)CCS)(COC(=O)CCS)COC(=O)CCS ; CC(S)CC(=O)OCC(COC(=O)CC(C)S)(COC(=O)CC(C)S)COC(=O)CC(C)S]

melting said one or more dicarboxylic acids in said first mixture by heating said first mixture to highest melting point of the one or more dicarboxylic acids in said first mixture; degassing said first mixture, preferably said degassing comprises degassing by placing said first mixture under vacuum; adding a catalyst selected from the group consisting of a Lewis Acid or non-nucleophilic base and mixtures thereof to said degassed first mixture, preferably said nucleophilic base is selected from the group of nucleophilic bases having one or more of the structures below:

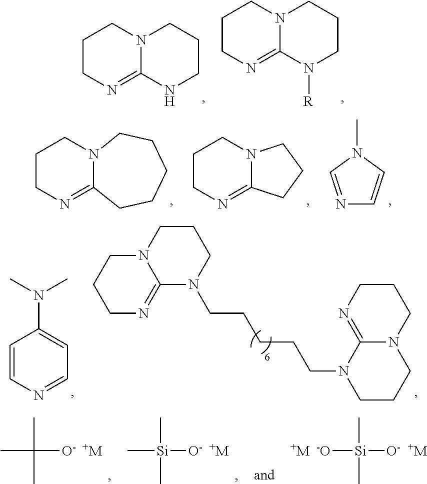

wherein R is a C₁ to C₁₀ alkyl; preferably said R is -methyl, -isopropyl; and M is a counteranion; preferably said M is potassium, sodium, tetramethyl ammonium; and preferably said Lewis Acid is selected from the group of Lewis Acids having one or more of the structures below:

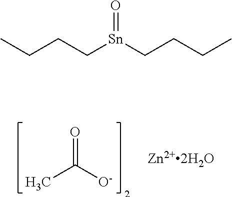

more preferably said one or more catalysts has the following structure:

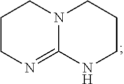

and
placing said degassed first mixture comprising said catalyst into a mold and heating said catalyst containing degassed first mixture in said mold to cure.

Applicants disclose a process of making an oligosiloxane epoxy covalent adaptable network according to the previous paragraph wherein said one or more oligosiloxane epoxides and said one or more carboxylic acids and/or one or more multifunctional thiols are present, prior to being reacted, in a stoichiometric ratio of from about 2:1 to about 1:2, preferably said one or more oligosiloxane epoxides and said one or more carboxylic acids are present, prior to being reacted, in a stoichiometric ratio of from about 1.5:1 to about 1:1.5, more preferably said one or more oligosiloxane epoxides and said one or more carboxylic acids are present, prior to being reacted, in a stoichiometric ratio of from about 1:0.9 to about 0.9:1 and/or wherein said one or more oligosiloxane epoxides and said one or more multifunctional thiols, are present, prior to being reacted in an epoxy:thiol ratio from about 2:1 to about 1:2, preferably said one or more oligosiloxane epoxides and said one or more one or more multifunctional thiols, being present prior to being reacted, in an epoxy:thiol ratio from about 1.5:1 to about 1:1.5, more preferably said one or more oligosiloxane epoxides and said one or more multifunctional thiols being present, prior to being reacted, in an epoxy:thiol ratio of from about 1:0.9 to about 0.9:1.

Applicants disclose a process of making an oligosiloxane epoxy covalent adaptable network according to the previous two paragraphs of this process disclosure section of this specification wherein said catalyst is added to said degassed first mixture at a level of 5 mole % based on said one or more dicarboxylic acids' total carboxylic acid moieties and said one or more multifunctional thiols.

Applicants disclose a process of making an oligosiloxane epoxy covalent adaptable network according to the previous three paragraphs of this process disclosure section of this specification wherein heating said degassed first mixture comprising said catalyst in said mold to cure comprises heating said degassed first mixture comprising said catalyst in said mold to a temperature of about 100° C. to about 175° C., preferably heating said degassed first mixture comprising said catalyst in said mold to cure comprises heating said degassed first mixture comprising said catalyst in said mold to a temperature of about 150° C. to about 170° C., preferably said heating is for a time of from about 1 hour to 14 hours, more preferably said heating is conducted for about 1.8 hours to about 2.2 hours.

Applicants disclose a process of making an oligosiloxane epoxy covalent adaptable network according to the first three paragraphs of this process disclosure section of this specification using a multifunctional thiol, wherein heating said degassed first mixture comprising said catalyst in said mold to cure comprises heating said degassed first mixture comprising said catalyst in said mold to a temperature of about 20° C. to about 175° C., preferably heating said degassed first mixture comprising said catalyst in said mold to cure comprises heating said degassed first mixture comprising said catalyst in said mold to a temperature of about 25° C. to about 170° C., preferably said heating is for a time of from about 1 hour to 14 hours.

Applicants disclose a process of making an oligosiloxane epoxy covalent adaptable network according to the previous five paragraphs of this process disclosure section of this specification wherein said degassed first mixture comprising said catalyst is heated in said mold for a portion of said about 14 hours and then removed from said mold and heated outside of said mold for the remaining portion of said about 14 hours, preferably said degassed first mixture comprising said catalyst is heated in said mold for about 2 hours and then degassed first mixture comprising said catalyst is removed from said mold and heated outside of said mold for the remaining portion of said about 14 hours.

Applicants disclose a process of recycling an oligosiloxane epoxy covalent adaptable network according to the first three paragraphs of this specification's section titled “Oligosiloxane Epoxy Covalent Adaptable Networks and Articles Comprising Same” and/or an oligosiloxane epoxy covalent adaptable network made according to the processes of the previous six paragraphs of this section of this specification titled “Processes of Making and Recycling Oligosiloxane Epoxy Covalent Adaptable Networks”, said process comprising heating and applying pressure to said oligosiloxane epoxy covalent adaptable network according to the first two paragraphs of this specification's section titled “Oligosiloxane Epoxy Covalent Adaptable Networks and Articles Comprising Same” and/or an oligosiloxane epoxy covalent adaptable network made according to the processes of the previous five paragraphs of this section of this specification titled “Processes of Making and Recycling Oligosiloxane Epoxy Covalent Adaptable Networks”, while introducing said oligosiloxane epoxy covalent adaptable network according to the first two paragraphs of this specification's section titled “Oligosiloxane Epoxy Covalent Adaptable Networks and Articles Comprising Same” and/or an oligosiloxane epoxy covalent adaptable network made according to the processes of the previous five paragraphs of this section of this specification titled “Processes of Making and Recycling Oligosiloxane Epoxy Covalent Adaptable Networks”, into a mold.

In Applicants' process of making an oligosiloxane epoxy covalent adaptable network, the reagent monomers can be cured in a way where the epoxide equivalent weight (eew) of the epoxide monomer is used to determine the amount of monomers needed for the desired molar ratio of carboxylic acid or multifunctional thiol to epoxide in each network synthesis. The eew may be obtained from the supplier's Certificate of Analysis if commercially available and by 1H-NMR spectroscopy analysis through the addition of an appropriate internal standard to quantify the moles of epoxide present within the oligosiloxane. Said adaptable networks were synthesized in a way where the dicarboxylic acid, or multifunctional thiol, and the oligosiloxane diepoxide are combined and stirred while being heated until all solids are melted/dissolved in the oligosiloxane liquid. Then, the said solution is degassed through stirring under heat and vacuum for a set period of time. Once deaeration slows, the base catalyst may be added and mixed into solution while continued degassing for a set period of time. The reaction mixture may then be pour-casted into preheated molds and cured at a preset temperature for an allotted time.

Preferably, when using carboxylic acids, the reagent monomers can be cured in a way where the epoxide equivalent weight (eew) of each oligosiloxane diepoxide monomer is used to determine the ratio of monomers in each network synthesis. Preferably, the eew is calculated by 1H-NMR spectroscopy using an internal standard. To synthesize the adaptable networks, the dicarboxylic acid (0.01 mol, 0.02 mol COOH) and the oligosiloxane diepoxide (0.02 mol epoxide based on eew) are combined in a round bottom flask and stirred while being heated to approximately 145° C. After 5 min, the solution is degassed by stirring under heat and vacuum (˜100 torr) for 15 min. Once the bubbling slowed, the 1,5,7-triazabicyclo[4.4.0]dec-5-ene catalyst (TBD) (5 mol % w.r.t. COOH, 0.0005 mol) is added to the flask and mixed into solution while under vacuum for 30 sec. The reaction mixture is then pour-casted into preheated polytetrafluoroethylene (PTFE) molds and cured. Initial curing at 150° C. for 2 hours in the mold is followed by removing samples from the molds and curing for 12 hours at 150° C. After this time, materials are allowed to cool and subsequently used for testing.

To synthesize the adaptable networks using thiol monomers, the thiols and the oligosiloxane diepoxide are weighed out in separate 20 mL scintillation vials while maintaining a 1:1 thiol:epoxy ratio. 1,5,7-triazabicyclo[4.4.0]dec-5-ene catalyst (TBD) (5 mol %) is added to the vial with the thiols and mixed into solution until fully dissolved. The epoxy monomer is subsequently poured into the thiols/TBD vial and the reaction mixture is then pour-casted into polytetrafluoroethylene (PTFE) molds and cured at 150° C. overnight. After this time, materials are allowed to cool and subsequently used for testing.

### Use of Oligosiloxane Epoxy Covalent Adaptable Networks

The polymer networks disclosed herein may be used for almost any application requiring a polymer. The covalent adaptable network articles here may be particularly suitable for applications where polymer welding, reprocessing and self-healing is desired. Such applications include functional coatings, compatibilizing agents, soft robotics, welding of laminates or disparate materials, and composite materials. This may include but is not limited to strain sensors and conductors, ultrasound imaging, haptics, electromagnetic shielding and other applications that rely on soft materials and composites.

### Test Methods

### Thermogravimetric Analysis

A Discovery TGA 5500 (TA Instruments) was used to perform thermogravimetric analysis of the covalent adaptable networks by heating samples to 800° C. under nitrogen at 10° C./min.

### Differential Scanning Calorimetry

Glass transition temperatures were determined using differential scanning calorimetry with a Discovery DSC2500 (TA Instruments). Samples were enclosed in a hermetic aluminum pan and tested using a heat-cool-heat cycle at a rate of 5° C./min under nitrogen. Starting temperatures varied between about −75 to −80° C. depending on the siloxane length since longer chain siloxanes exhibit a lower glass transition temperatures All samples were heated up to 160° C. to ensure that there were no exothermic peaks from additional curing were present.

### Dynamic Mechanical Analysis

Cured articles were analyzed via dynamic mechanical analysis using a Discovery DMA 850 (TA Instruments). Materials were cut into small strips of 2 mm×1 mm×22 mm (L×W×H) using an Epilog laser cutter. The materials were tested with a temperature sweep in tension using a strain of 0.1%, a frequency of 1.0 Hz, and an oscillation temperature ramp of 5° C./min from −90 to 100° C. Samples had an initial preload of 0.01 N and a soak time of 60 sec to thermally equilibrate the sample before testing.

### Stress Relaxation

Isothermal stress relaxation experiments were performed using a DMA850 (TA Instruments). Samples were thermally equilibrated for one minute prior to the experiment at which point an axial strain of 1.0% was applied over a relaxation time of 50 min. The measured stress was normalized for comparison.

Reprocessing of the oligosiloxane epoxy covalent adaptable networks The materials were reprocessed by cutting into small pieces and pressing together in a hot press at elevated temperatures. The cut article pieces were placed in the center of two metal plates along with a shim to dictate sample thickness, and the plates were pressed together while being heated to approximately 150° C. The metal plates were wrapped in a Kapton film to facilitate sample release. The sample was preheated for 15 min before pressing for 30-60 minutes under 4000-5000 lbs of force.

### Tensile Testing

Mechanical properties of the materials were evaluated by tensile testing of the adaptable network materials. Dogbone specimens were prepared following ASTM D638 Type V specifications, with slight modifications to the to fit in the tensile testing stage. Specimens were tested using a TST350 Temperature Controlled Tensile Stress Testing Stage (Linkam Scientific Instruments). Tests were performed at a rate of 2 mm/min with a grip separation of 18.5 mm.

### Examples

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

Example 1. Production of an oligosiloxane epoxy covalent adaptable network An adaptable network is produced via the synthesis route below:

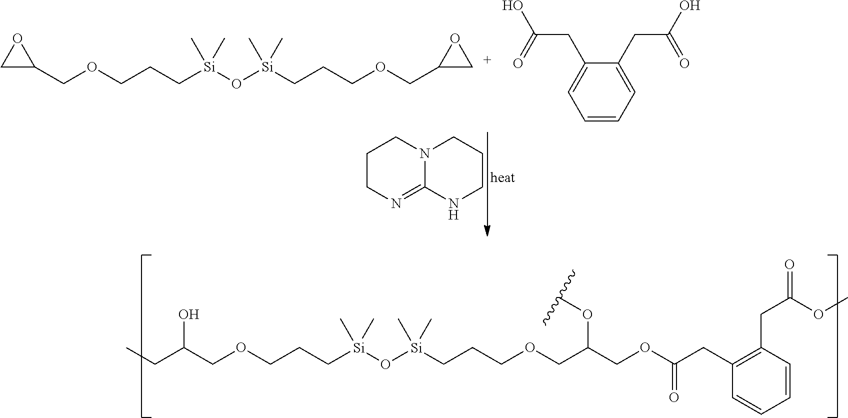

Crosslinking between polymer chains occurred through transesterification and/or siloxane exchange pathways, catalyzed by the added 1,5,7-Triazabicyclo[4.4.0]dec-5-ene catalyst, to give a crosslinked network with a glass transition temperature of approximately −18° C. (via DSC) and 11° C. (via DMA), determined in accordance with the test method provided in the Test Methods section of this specification for differential scanning calorimetry. Furthermore, this material had approximately thermal degradation temperature of 243° C. (5% weight loss), a Young's modulus of 1.7 MPa, tensile strength of 0.5 MPa and strain at break of 40%. The dynamic bond exchange reactions allowed for the reprocessing of the cured adaptable network, determined in accordance with the test method provided in the Test Methods section of this specification for reprocessing of the adaptable networks.

| | | | Young's | Tensile | Elongation | |
|---|---|---|---|---|---|---|
| E′ (T_{g} + 50° C.) | T_{d}^{a} | T_{g}^{b} | Modulus | Strength | at Break | Toughness |
| (MPa) | (° C.) | (° C.) | (MPa) | (MPa) | (%) | (kJ/m³) |
| 2.1 ± 0.3 | 243 | 11 ± 1 | 1.7 ± 0.3 | 0.5 ± 0.1 | 40 ± 3 | 120 ± 30 |

^{a}5% weight loss
^{b}from DMA

Example 2. Production of an oligosiloxane epoxy covalent adaptable network An adaptable network is produced via the synthesis route below:

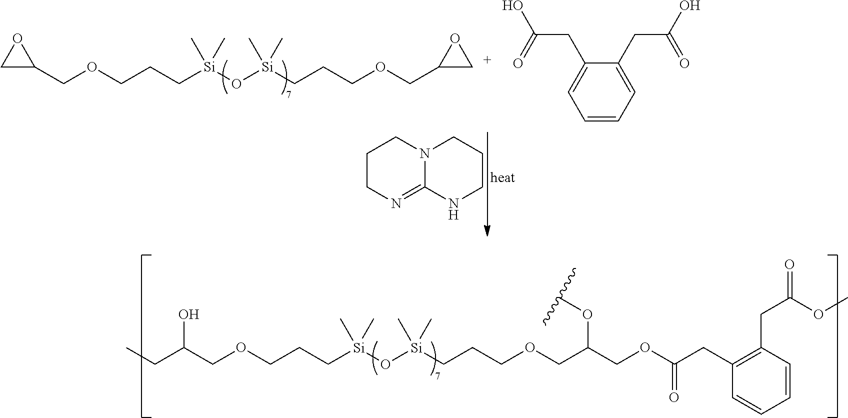

Crosslinking between polymer chains occurred through transesterification and/or siloxane exchange pathways, catalyzed by the added 1,5,7-Triazabicyclo[4.4.0]dec-5-ene catalyst, to give a crosslinked network with a glass transition temperature of approximately −57° C. (via DSC) and −25° C. (via DMA), determined in accordance with the test method provided in the Test Methods section of this specification for differential scanning calorimetry. Furthermore, this material had an approximately thermal degradation temperature of 254° C. (5% weight loss), Young's modulus of 1.30 MPa, tensile strength of 0.25 MPa and strain at break of 24%. The dynamic bond exchange reactions allowed for the reprocessing of the cured adaptable network, determined in accordance with the test method provided in the Test Methods section of this specification for reprocessing of the adaptable networks.

| | | | Young's | Tensile | Elongation | |
|---|---|---|---|---|---|---|
| E′ (T_{g} + 50° C.) | T_{d}^{a} | T_{g}^{b} | Modulus | Strength | at Break | Toughness |
| (MPa) | (° C.) | (° C.) | (MPa) | (MPa) | (%) | (kJ/m³) |
| 0.84 ± 0.06 | 254 | −25 ± 2 | 1.3 ± 0.1 | 0.25 ± 0.01 | 24 ± 2 | 30 ± 9 |

^{a}5% weight loss
^{b}from DMA

Example 3. Production of an oligosiloxane epoxy covalent adaptable network An adaptable network is produced according to the synthesis of Example 1 except with the addition of

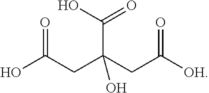 [SMILES: O=C(O)CC(O)(CC(=O)O)C(=O)O]

Up to 40 mole percent of carboxylic acid groups were replaced with carboxylic acid groups from a tricarboxylic acid (citric acid) to modulate crosslink density within the network derived from oligosiloxane diepoxide where n=1 and a representative network structure is shown

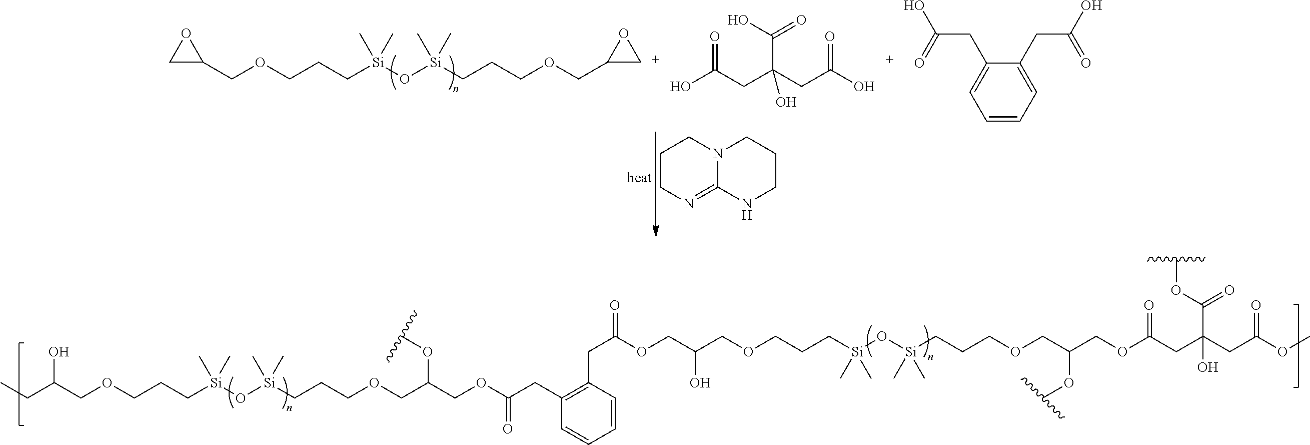

| | | | Young's | Tensile | Elongation | |
|---|---|---|---|---|---|---|
| E′ (T_{g} + 50° C.) | T_{d}^{a} | T_{g}^{b} | Modulus | Strength | at Break | Toughness |
| (MPa) | (° C.) | (° C.) | (MPa) | (MPa) | (%) | (kJ/m³) |
| 4.10 ± 0.06 | 239 | 19 ± 1 | 4.4 ± 0.6 | 0.9 ± 0.1 | 24 ± 4 | 120 ± 30 |

^{a}5% weight loss
^{b}from DMA

Example 4. Production of an oligosiloxane epoxy covalent adaptable network An adaptable network is produced according to the synthesis of Example 1 except with the addition of

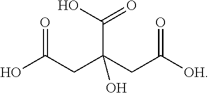 [SMILES: O=C(O)CC(O)(CC(=O)O)C(=O)O]

Up to 40 mole percent of carboxylic acid groups were replaced with carboxylic acid groups from a tricarboxylic acid (citric acid) to modulate crosslink density within the network derived from oligosiloxane diepoxide where n=7 and a representative network structure is shown

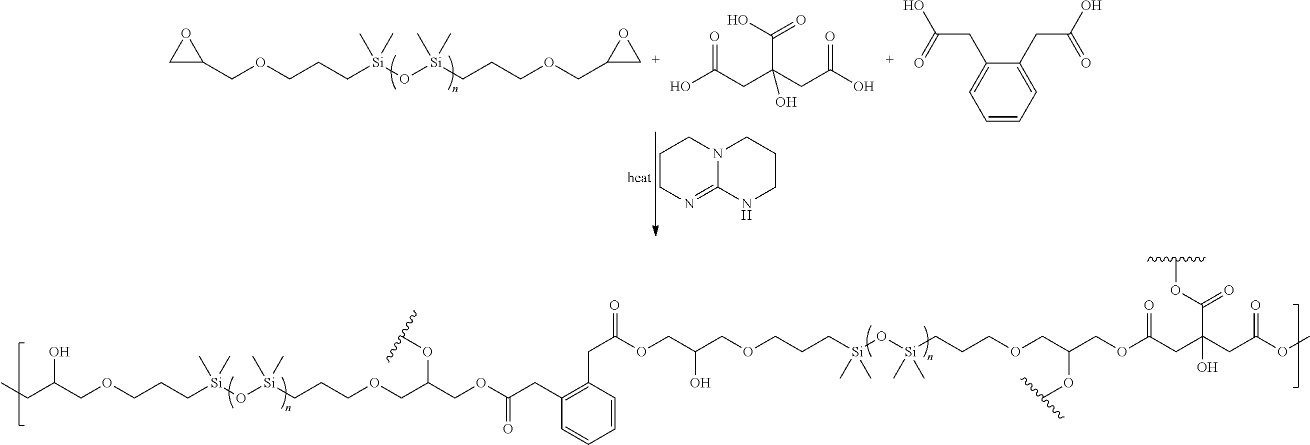

| | | | Young's | Tensile | Elongation | |
|---|---|---|---|---|---|---|
| E′ (T_{g} + 50° C.) | T_{d}^{a} | T_{g}^{b} | Modulus | Strength | at Break | Toughness |
| (MPa) | (° C.) | (° C.) | (MPa) | (MPa) | (%) | (kJ/m³) |
| 2.397 ± 0.005 | 246 | −23.6 ± 0.2 | 2.1 ± 0.2 | 0.44 ± 0.09 | 27 ± 6 | 70 ± 20 |

^{a}5% weight loss
^{b}from DMA

Example 5. Production of an oligosiloxane epoxy covalent adaptable network An adaptable network is produced via the synthesis route below:

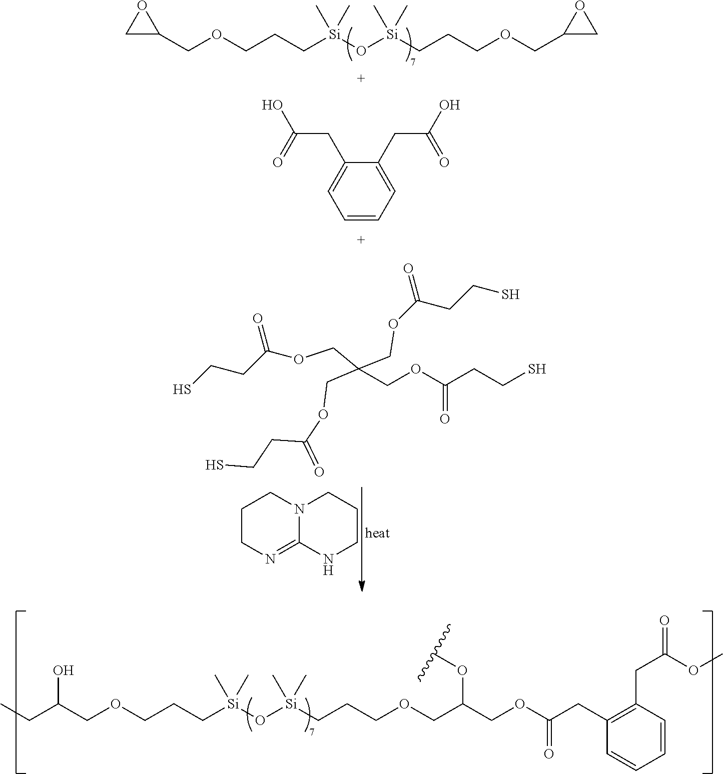

Crosslinking between polymer chains occurred through transesterification and/or siloxane exchange pathways, catalyzed by the added 1,5,7-Triazabicyclo[4.4.0]dec-5-ene catalyst, to give a crosslinked network. Furthermore, this material had a Young's modulus of 2.3 MPa, tensile strength of 0.4 MPa and strain at break of 21%. The dynamic bond exchange reactions allowed for the reprocessing of the cured adaptable network, determined in accordance with the test method provided in the Test Methods section of this specification for reprocessing of the adaptable networks.

| | Young's | Tensile | Elongation | |
|---|---|---|---|---|
| | Modulus | Strength | at Break | Toughness |
| Network | (MPa) | (MPa) | (%) | (kJ/m³) |
| Example 5 | 2.3 ± 0.2 | 0.4 ± 0.1 | 21 ± 5 | 50 ± 20 |

Example 6. Production of an oligosiloxane epoxy covalent adaptable network An adaptable network is produced via the synthesis route below:

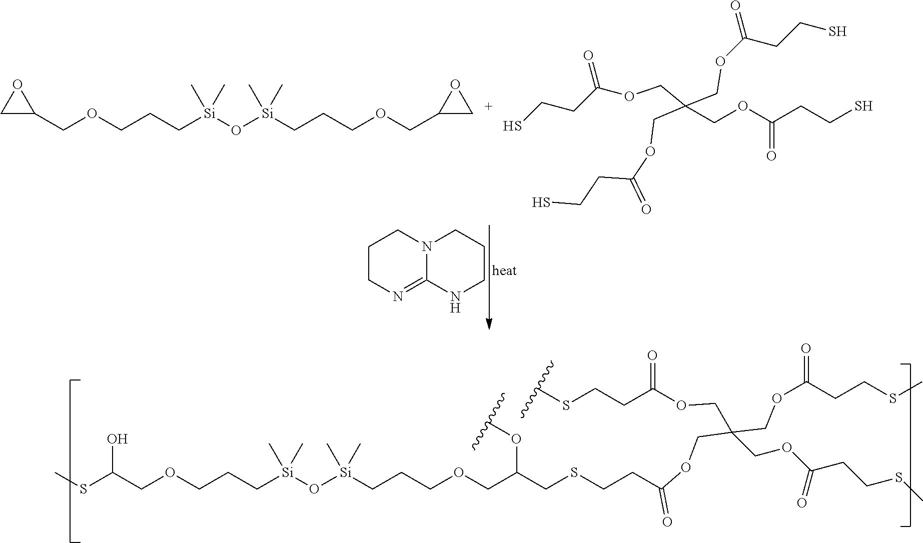

Crosslinking between polymer chains occurred through transesterification and/or siloxane exchange pathways, catalyzed by the added 1,5,7-Triazabicyclo[4.4.0]dec-5-ene catalyst, to give a crosslinked network. Furthermore, this material had a Young's modulus of 7.9 MPa, tensile strength of 0.7 MPa and strain at break of 11%. The dynamic bond exchange reactions allowed for the reprocessing of the cured adaptable network, determined in accordance with the test method provided in the Test Methods section of this specification for reprocessing of the adaptable networks.

| | Young's | Tensile | Elongation | |
|---|---|---|---|---|
| | Modulus | Strength | at Break | Toughness |
| Network | (MPa) | (MPa) | (%) | (kJ/m³) |
| Example 6 | 7.9 ± 0.7 | 0.7 ± 0.1 | 11 ± 2 | 40 ± 10 |

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. An oligosiloxane epoxy covalent adaptable network derived from the reaction of:
a) one or more siloxane diepoxides;
b) one or more dicarboxylic acids and/or one or more multifunctional thiols; and
c) a catalyst selected from the group consisting of a Lewis Acid or non-nucleophilic base and mixtures thereof.

2. The oligosiloxane epoxy covalent adaptable network of claim 1, said oligosiloxane epoxy covalent adaptable network being derived from the reaction of:
a) one or more siloxane diepoxides have a structure selected from the group consisting of: 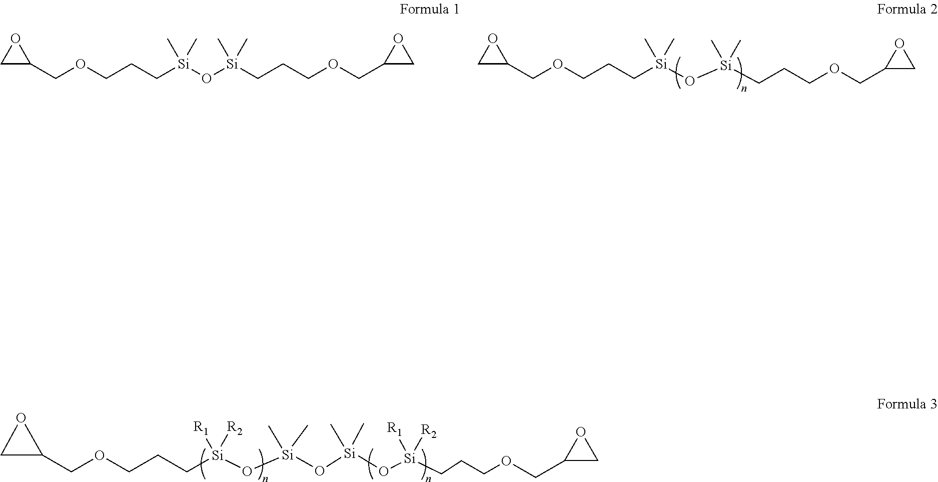
wherein for said Formula 1, Formula 2 and Formula 3 each indice n is independently an integer from 0 to 10 and for Formula 3, R₁ and R₂ are each independently an alkyl moiety, an aryl moiety or an alkoxy moiety;
b) said one or more dicarboxylic acids have a structure selected from the group consisting of: 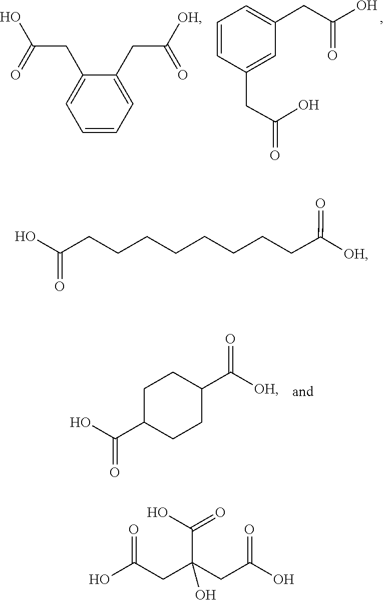
and said multifunctional thiols have a structure selected from the group consisting of: 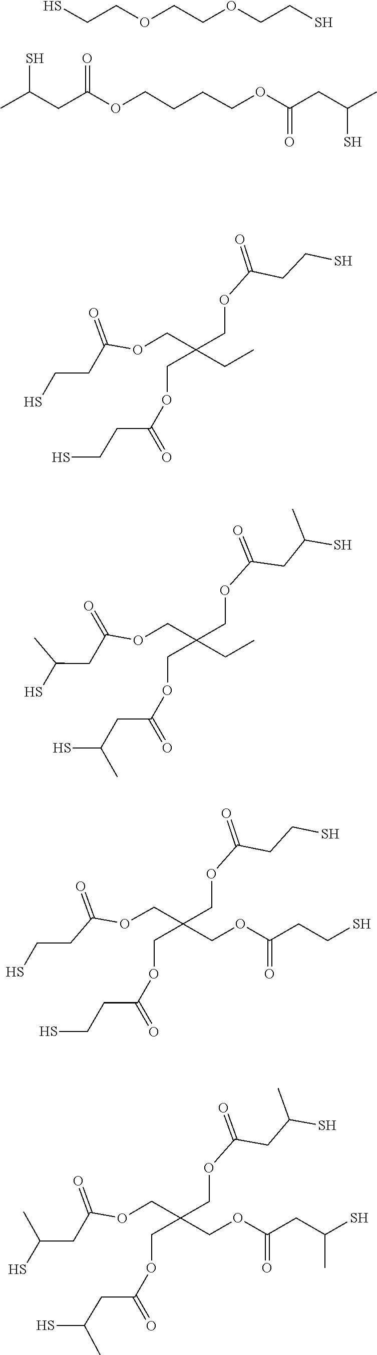
c) said non-nucleophilic base is selected from the group of non-nucleophilic bases having one or more of the structures below: 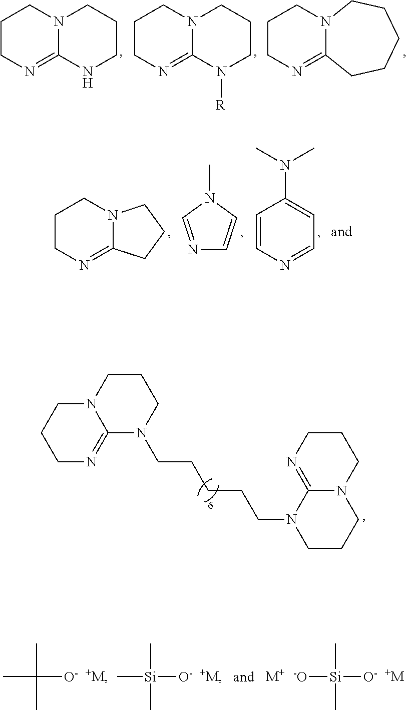
wherein R is a C₁ to C₁₀ alkyl and M is a counteranion; and
said Lewis Acid is selected from the group of Lewis Acids having one or more of the structures below:

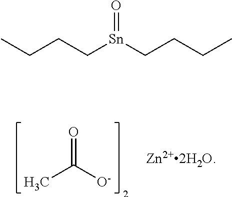

3. The oligosiloxane epoxy covalent adaptable network of claim 1, said oligosiloxane epoxy covalent adaptable network being derived from the reaction of:
a) one or more siloxane diepoxides have a structure selected from the group consisting of: 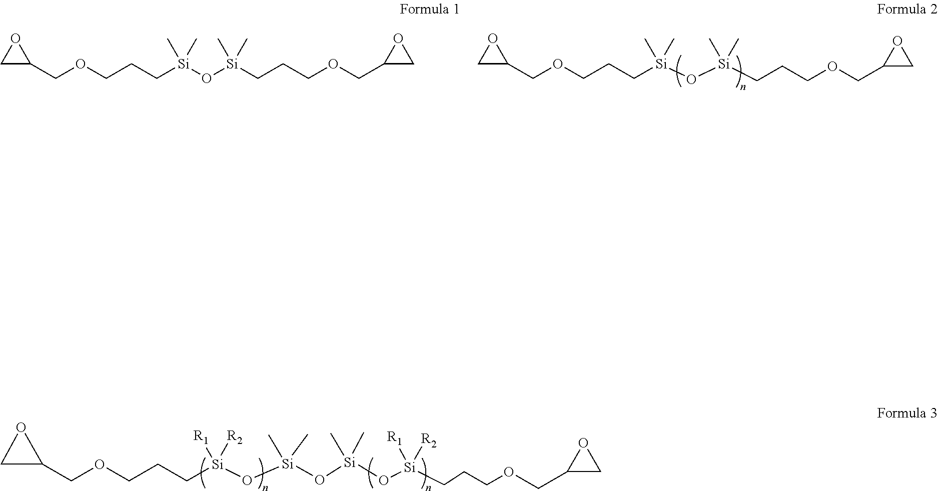
wherein for said Formula 1, Formula 2 and Formula 3 each indice n is independently an integer from 1 to 5; and for Formula 3, R₁, and R₂ are each independently —CH₃, —CH₂CH₃, —CH₂CH₂CH₃, —C₆H₅, —C₁₀H₃, —OCH₃, —OCH₂CH₃;
b) said dicarboxylic acid has the following structure: 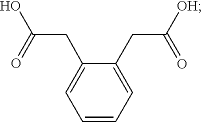 [SMILES: O=C(O)Cc1ccccc1CC(=O)O]
and
c) said non-nucleophilic base is selected from the group of non-nucleophilic bases having one or more of the structures below: 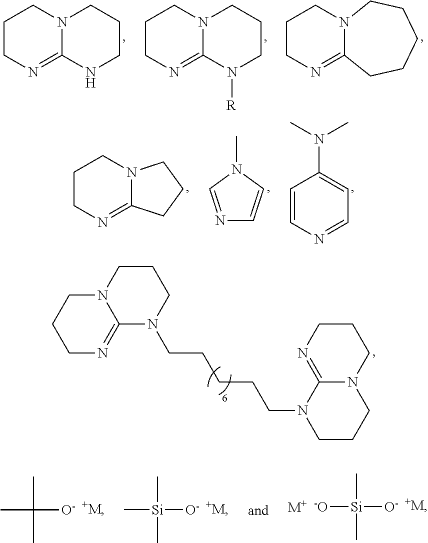
wherein R is -methyl or -isopropyl and M is potassium, sodium or tetramethyl ammonium.

4. The oligosiloxane epoxy covalent adaptable network of claim 1 said catalyst has the following structure:

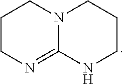

5. The oligosiloxane epoxy covalent adaptable network of claim 1 wherein said one or more oligosiloxane epoxides and said one or more carboxylic acids are present, prior to being reacted, in a stoichiometric ratio of from about 2:1 to about 1:2.

6. The oligosiloxane epoxy covalent adaptable network of claim 1 wherein said one or more oligosiloxane epoxides and said one or more carboxylic acids are present, prior to being reacted, in a stoichiometric ratio of from about 1.5:1 to about 1:1.5.

7. The oligosiloxane epoxy covalent adaptable network of claim 1 wherein said one or more oligosiloxane epoxides and said one or more carboxylic acids are present, prior to being reacted, in a stoichiometric ratio of from about 1:0.9 to about 0.9:1.

8. The oligosiloxane epoxy covalent adaptable network of claim 1 wherein said one or more oligosiloxane epoxides and said one or more multifunctional thiols, are present, prior to being reacted in an epoxy:thiol ratio from about 2:1 to about 1:2.

9. The oligosiloxane epoxy covalent adaptable network of claim 1 wherein said one or more oligosiloxane epoxides and said one or more one or more multifunctional thiols, are present prior to being reacted, in an epoxy:thiol ratio from about 1.5:1 to about 1:1.5.

10. The oligosiloxane epoxy covalent adaptable network of claim 1 wherein said one or more oligosiloxane epoxides and said one or more multifunctional thiols are present, prior to being reacted, in an epoxy:thiol ratio of from about 1:0.9 to about 0.9:1.

11. A process of making an oligosiloxane epoxy covalent adaptable network comprising:
a) combining one or more siloxane diepoxides;
b) one or more dicarboxylic acids and/or one or more multifunctional thiols,
c) melting said one or more dicarboxylic acids in said first mixture by heating said first mixture to highest melting point of the one or more dicarboxylic acids in said first mixture;
d) degassing said first mixture;
e) adding a catalyst selected from the group consisting of a Lewis Acid or non-nucleophilic base and mixtures thereof to said degassed first mixture; and
f) placing said degassed first mixture comprising said catalyst into a mold and heating said catalyst containing degassed first mixture in said mold to cure.

12. The process of making an oligosiloxane epoxy covalent adaptable network of claim 11, wherein said:
a) one or more siloxane diepoxides have a structure selected from the group consisting of: 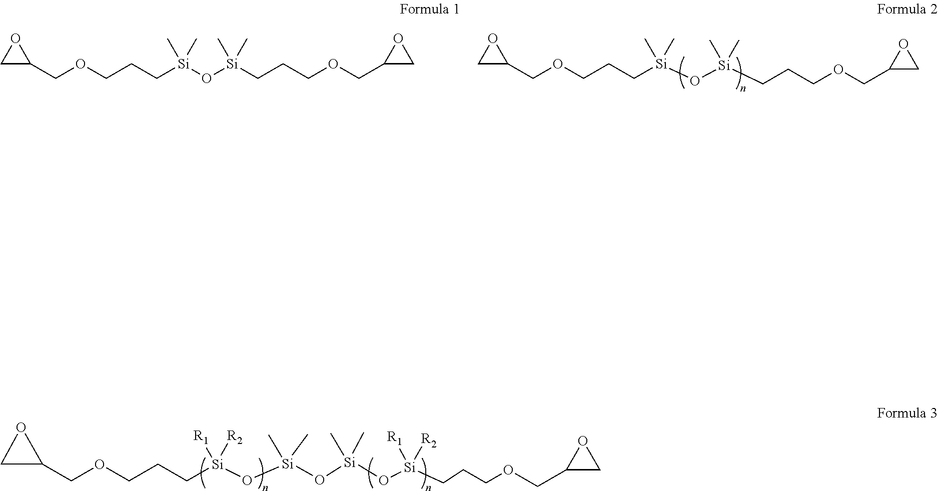
wherein for said Formula 1, Formula 2 and Formula 3 each indice n is independently an integer from 0 to 10 and for Formula 3, R₁ and R₂ are each independently an alkyl moiety, an aryl moiety or an alkoxy moiety;
b) said one or more dicarboxylic acids have a structure selected from the group consisting of: 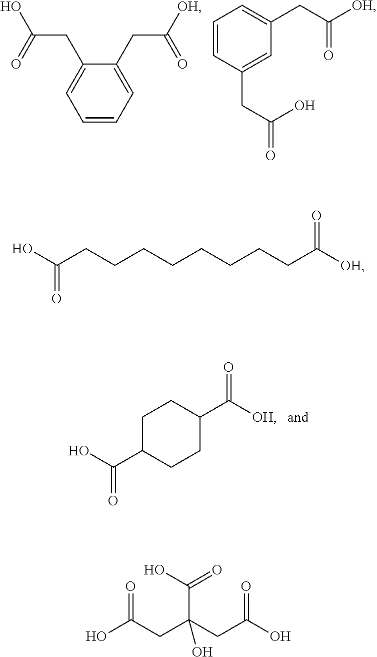
and said multifunctional thiols have a structure selected from the group consisting of: 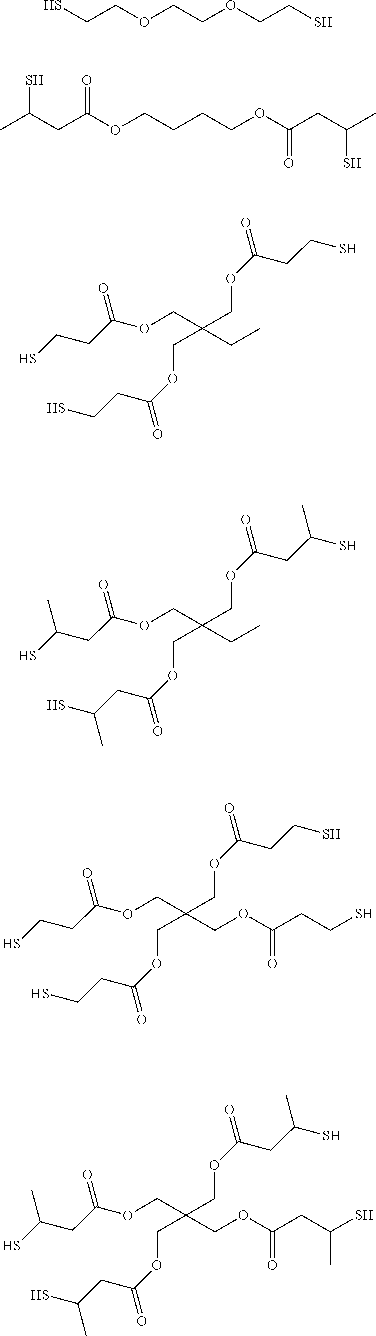 [SMILES: SCCOCCOCCS ; CC(S)CC(=O)OCCCCOC(=O)CC(C)S ; CCC(COC(=O)CCS)(COC(=O)CCS)COC(=O)CCS ; CCC(COC(=O)CC(C)S)(COC(=O)CC(C)S)COC(=O)CC(C)S ; O=C(CCS)OCC(COC(=O)CCS)(COC(=O)CCS)COC(=O)CCS ; CC(S)CC(=O)OCC(COC(=O)CC(C)S)(COC(=O)CC(C)S)COC(=O)CC(C)S]
c) said non-nucleophilic base is selected from the group of non-nucleophilic bases having one or more of the structures below: 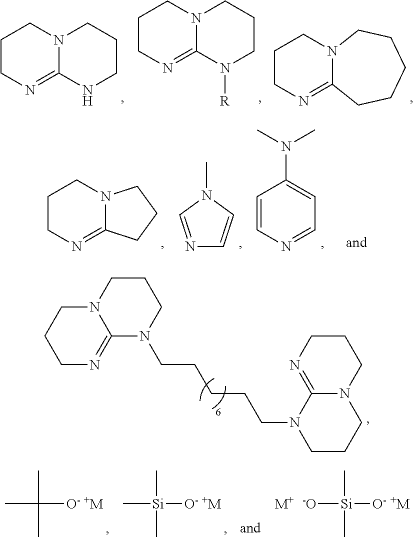
wherein R is a C₁ to C₁₀ alkyl and M is a counteranion; and
said Lewis Acid is selected from the group of Lewis Acids having one or more of the structures below: 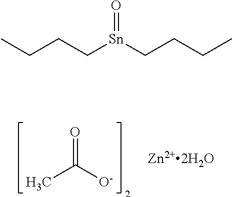
and said degassing comprises degassing by placing said first mixture under vacuum.

13. The process of making an oligosiloxane epoxy covalent adaptable network of claim 11, wherein said:
a) one or more siloxane diepoxides have a structure selected from the group consisting of: 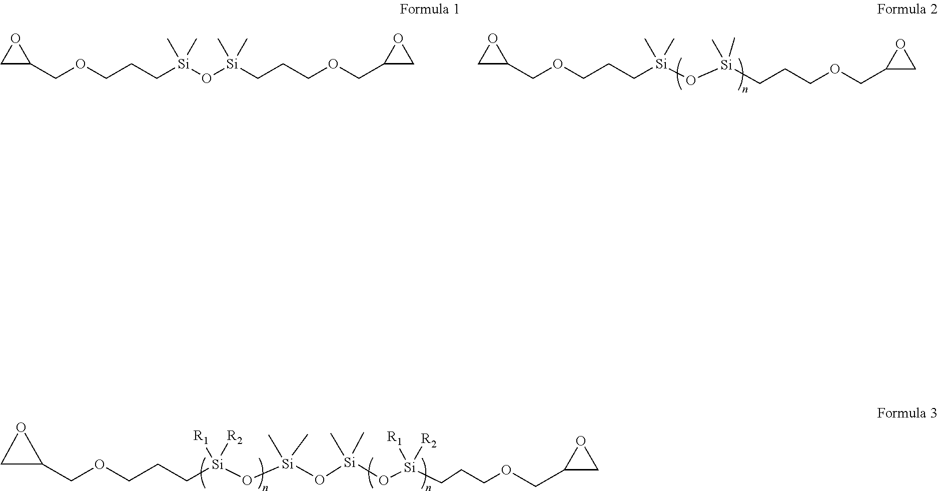
wherein for said Formula 1, Formula 2 and Formula 3 each indice n is independently an integer from 1 to 5; and for Formula 3, R₁, and R₂ are each independently —CH₃, —CH₂CH₃, —CH₂CH₂CH₃, —C₆H₅, —C₁₀H₈, —OCH₃, —OCH₂CH₃;
b) said dicarboxylic acid has the following structure: 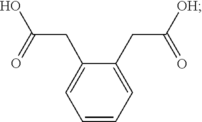 [SMILES: O=C(O)Cc1ccccc1CC(=O)O]
and
c) said non-nucleophilic base is selected from the group of non-nucleophilic bases having one or more of the structures below: 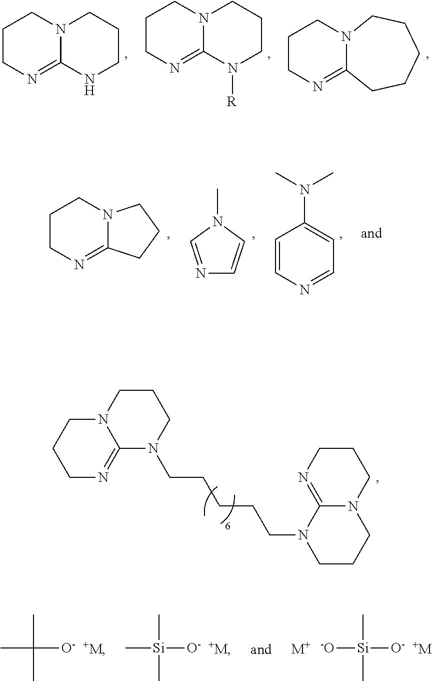
wherein R is -methyl or -isopropyl and M is potassium, sodium or tetramethyl ammonium.

14. The process of making an oligosiloxane epoxy covalent adaptable network of claim 11, wherein said catalyst has the following structure:

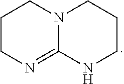

15. The process of claim 11 wherein said one or more oligosiloxane epoxides and said one or more carboxylic acids, are present, prior to being reacted in a stoichiometric ratio of from about 2:1 to about 1:2.

16. The process of claim 11 wherein said one or more oligosiloxane epoxides and said one or more carboxylic acids, are present prior to being reacted, in a stoichiometric ratio of from about 1.5:1 to about 1:1.5.

17. The process of claim 11 wherein said one or more oligosiloxane epoxides and said one or more carboxylic acids are present, prior to being reacted, in a stoichiometric ratio of from about 1:0.9 to about 0.9:1.

18. The process of claim 11 wherein said one or more oligosiloxane epoxides and said one or more multifunctional thiols, are present, in an epoxy:thiol ratio from about 2:1 to about 1:2.

19. The process of claim 11 said one or more oligosiloxane epoxides and said one or more one or more multifunctional thiols, being present, prior to being reacted, in an epoxy:thiol ratio from about 1.5:1 to about 1:1.5.

20. The process of claim 11 wherein said one or more oligosiloxane epoxides and said one or more multifunctional thiols being present, prior to being reacted, in an epoxy:thiol ratio of from about 1:0.9 to about 0.9:1.

21. The process of claim 11 wherein said catalyst is added to said degassed first mixture at a level of 5 mole % based on said one or more dicarboxylic acids' total carboxylic acid moieties and said one or more multifunctional thiols.

22. The process of claim 11 wherein heating said degassed first mixture comprising said catalyst in said mold to cure comprises heating said degassed first mixture comprising said catalyst in said mold to a temperature of about 100° C. to about 175° C.

23. The process of claim 11 wherein heating said degassed first mixture comprising said catalyst in said mold to cure comprises heating said degassed first mixture comprising said catalyst in said mold to a temperature of about 150° C. to about 170° C., and said heating is for a time of from about 1 hour to 14 hours.

24. The process of claim 11 wherein heating said degassed first mixture comprising said catalyst in said mold to cure comprises heating said degassed first mixture comprising said catalyst in said mold to a temperature of about 150° C. to about 170° C., and said heating is conducted for about 1.8 hours to about 2.2 hours.

25. The process of making an oligosiloxane epoxy covalent adaptable network according to claim 11 using a multifunctional thiol, wherein heating said degassed first mixture comprising said catalyst in said mold to cure comprises heating said degassed first mixture comprising said catalyst in said mold to a temperature of about 20° C. to about 175.

26. The process of making an oligosiloxane epoxy covalent adaptable network according to claim 11 using a multifunctional thiol, wherein heating said degassed first mixture comprising said catalyst in said mold to cure comprises heating said degassed first mixture comprising said catalyst in said mold to a temperature of about 25° C. to about 170° C. and said heating is for a time of from about 1 hour to 14 hours.

27. The process of claim 11 wherein said degassed first mixture comprising said catalyst is heated in said mold for a portion of said about 14 hours and then removed from said mold and heated outside of said mold for the remaining portion of said about 14 hours.

28. The process of claim 11 wherein said degassed first mixture comprising said catalyst is heated in said mold for about 2 hours and then degassed first mixture comprising said catalyst is removed from said mold and heated outside of said mold for the remaining portion of said about 14 hours.

29. An article comprising an oligosiloxane epoxy covalent adaptable network according to claim 1,

30. An article according to claim 29, said article preferably being an actuator, coating material or a soft robotic structural unit.

31. A process of recycling an oligosiloxane epoxy covalent adaptable network according to claim 1, said process comprising heating and applying pressure to said oligosiloxane epoxy covalent adaptable network while introducing said oligosiloxane epoxy covalent adaptable network into a mold.
